(19) United States
(12) Patent Application Publication
(10) Pub. No.: US 2017/0347687 A1
(43) Pub. Date: Dec. 7, 2017

(54) TWO-COMPONENT ANIMAL FOOD COMPOSITION

(71) Applicant: Adolf Rupp Herrnmühle OG, Hörbranz (AT)

(72) Inventor: Christoph Rupp, Hörbranz (AT)

(21) Appl. No.: 15/518,026

(22) PCT Filed: Oct. 13, 2015
(86) PCT No.: PCT/AT2015/050254

§ 371 Date: May 10, 2017

(30) Foreign Application Priority Data
Oct. 14, 2014 (AT) GM 50161/2014

(51) Int. Cl. A23K 50/42; A23K 40/25; A23K 20/158; A23K 10/35; A23K 20/147

(52) U.S. Cl. CPC A23K 50/42; A23K 10/35; A23K 20/147; A23K 20/158; A23K 40/25

(57) ABSTRACT

The present invention relates to animal-feed compositions comprising two components, an outer component, which completely encloses an inner component, is harder than the inner component and contains potato flour and at least one ingredient selected from a fat, a protein or a combination of the same.

### DESCRIPTION OF THE INVENTION

The present invention relates to animal-feed compositions, especially multi-component animal-feed compositions, comprising an outer and an inner component, with increased digestibility and enhanced palatability.

By preference, the animal-feed composition is a cat-food composition.

### BACKGROUND TO THE INVENTION

Semi-moist animal-feed products are known in the prior art.

WO 2008/144234 A1 discloses an extruded animal-feed product which is made up from different extruded components. Extrusion of the individual components is required, wherein the individual ingredients form different portions.

EP 1 527 699 A1 describes a pet-food product with at least two phase-separated layers, wherein a lower base layer is formed from a solid foodstuff, and an upper layer consists of a jelly preparation, in which solid meat fragments reconstructed from meat mixture are embedded. No animal-feed composition consisting of an outer component which completely encloses an inner component has been presented.

U.S. Pat. No. 4,795,655 relates to a two-part pet food consisting of a base part and a filling. The filling comprises 30 to 40% by weight water. Neither of the two components contains potato flour and is free from cereal.

U.S. Pat. No. 4,229,485 shows a dried, cereal-based pet food made from flour-containing and protein-containing material enclosed by a coating made of liver and flour-containing material. Both components are based on cereal flour.

### OBJECT OF THE INVENTION

Starting from this prior art, the object of the present invention is to provide a storage-stable animal-feed composition with increased digestibility and enhanced palatability.

### BRIEF DESCRIPTION OF THE INVENTION

This object is achieved according to the invention by the characterising features of the independent claims.

The dependent claims develop the idea of the invention in an advantageous manner.

A multi-component animal-feed composition according to the invention comprises two components, an outer component, which preferably completely encloses an inner component, wherein the outer component contains potato flour and is harder than the inner component.

The texture of the animal-feed composition according to the invention can be determined, inter alia, by means of “Kramer shear cell”. The “Kramer shear cell” is a texture measuring method used for extruded foodstuffs, wherein a biting and respectively chewing with several teeth is simulated. Accordingly, the “Kramer shear cell” provides information about the bite characteristic, crunchiness and mechanical strength of the composition. During the measurement, 5 or 10 cutters/shear blades travel at a constant speed through a defined quantity of sample material, wherein they, shear and extrude the latter. As a result, a cutting force is obtained, which is required to cut through the sample material. This force is an indicator of the tenderness, toughness or mechanical strength of the sample material under investigation.

In a further embodiment, the multi-component animal-feed composition according to the invention comprises two components, an outer component, which preferably completely encloses an inner component, wherein the outer component contains pseudo-cereal and is harder than the inner component.

In the sense of the present invention, pseudo-cereal includes grain fruits of plant species which do not belong to the family of sweet grasses. They include, for example, quinoa, amaranth and buckwheat.

In one preferred embodiment, the outer component of the animal-feed composition according to the invention, which preferably completely encloses an inner component, comprises tapioca starch.

In a further preferred embodiment, the outer component of the animal-feed composition according to the invention, which preferably completely encloses an inner component, comprises starch from vegetables and fruit.

Vegetables and fruit in the sense of the present invention comprise beans, peas, lentils and tomatoes.

By preference, the inner component also contains potato flour.

The inner component can also advantageously contain pseudo-cereal.

By further preference, the inner component also advantageously contains tapioca starch.

The inner component also advantageously contains starch from vegetables and fruit according to the invention.

In one preferred embodiment, the animal-feed composition according to the invention comprises two components, an outer component, which completely encloses an inner component, wherein the outer component contains potato flour and furthermore at least one ingredient selected from a fat, a protein or a combination of the same and is harder than the inner component.

In one advantageous embodiment, the animal-feed composition according to the invention comprises two components, an outer component, which completely encloses an inner component, wherein the outer component contains potato flour and furthermore at least one ingredient selected from a fat, a protein, a carbohydrate, which is not cereal-based, or a combination of the same, and is harder than the inner component.

By further preference, the outer component of the animal-feed composition according to the invention comprises 2 to 10% by weight water, 8 to 15% by weight fat, 15 to 25% by weight carbohydrate (of which 25 to 40% by weight potato flour), 30 to 45% by weight proteins, with reference to the total weight of the outer component, and the inner component of the animal-feed composition according to the invention contains 2 to 5% by weight water, 35 to 60% by weight fat, 35 to 60% by weight carbohydrates (of which 35 to 60% by weight potato flour), 0.1 to 10% by weight proteins, with reference to the total weight of the inner component.

The combination of two components, an outer, harder component and an inner, softer component, wherein at least the outer component contains potato flour, improves the palatability by comparison with a feed product consisting only of one component.

Potato flour is characterised by very good water-binding properties. Surprisingly, through the potato flour in the outer and optionally the inner component of the animal-feed composition according to the invention, which comprises a lower stiffening capacity, for example, than maize starch or wheat starch, an optimal starch gelatinisation with higher viscosity is obtained. The animal-feed composition according to the present invention is therefore characterised by a uniform structure and pore density.

Under heating with water, starch grains swell to a multiple of their original volume. This swelling capacity is marked differently dependent upon the type of starch. This swelling capacity also gives an indication of the water-binding capacity of the starch.

For example, potato starch swells up to a thousand times the original volume. Tapioca starch, for example, swells up to 70 times the volume.

Cereal starches generally comprise a lower swelling capacity. Maize starch swells up to 24 times the volume and wheat starch up to 20 times the volume.

The outer component is preferably hard, by further preference crunchy and, through its smooth structure, preferably causes an improved sensation in the mouth of the consumer of the animal-feed composition according to the invention.

Furthermore, the acceptance of the animal-feed composition according to the invention based on potato flour is higher than that of animal feed based on cereal.

Furthermore, the animal-feed composition is characterised by good storage stability. Through the specific water binding of the potato flour, the desired consistency of the animal-feed composition according to the invention is retained and less retrogradation occurs.

Starch consists of the two components amylose and amylopectin, in different quantitative proportions. The structure of amylose is an un-branched chain of 100 to 1400 α-1,4-glycosidically bound D glucose units with a molecular weight of 15,000 to 200,000 g/mol. Amylopectin consists of α-1,4-glycosidically mutually bound D glucose monomers, to which, approximately every 15-30 monomers, α-1,6-glycosidically linked side-chain with approximately 15-25 D glucose units is appended. This leads to a tree-like branching. Amylopectin has a molecular weight of 10-700 million g/mol.

The starch component amylose is principally responsible for the retrogradation. Potato starch contains 20% amylose and accordingly, for example, less than the two cereal starches, maize starch (27% amylose) and wheat starch (28% amylose). By contrast, amylopectin has little influence on the starch retrogradation.

By preference, the outer component of the animal-feed composition is free from cereal constituents.

By further preference, the inner component of the animal-feed composition is free from cereal constituents.

Cereal constituents in the sense of the present invention are cereal components from the family of the sweet grasses. In particular, the term “cereal constituents” means cereal proteins.

Sweet grasses represent a plant family of the grass species. All cereals, such as wheat, rye, barley, oats, millet, maize and rice are counted among the family of the sweet grasses.

In a further preferred embodiment, at least the outer and/or the inner component of the animal-feed composition according to the invention is free of cereal-constituents, such as, cereal starch, husk parts and germling parts.

By preference, the outer component of the animal-feed composition is free from cereal components, such as wheat flour or maize.

By further preference, the outer and the inner component of the animal-feed composition is free from cereal-constituents such as wheat flour.

By particular preference, the outer component and/or the inner component is free from wheat flour and/or free from maize

In one advantageous embodiment, at least the outer component is free from cereal components from the family of the sweet grasses.

In a further preferred embodiment, at least the outer and/or the inner component of the animal-feed composition according to the invention is free of cereal-components from the family of the sweet grasses.

Advantageously, the outer and/or the inner component of the animal-feed composition according to the invention is free from cereal proteins

Through the use of potato flour, the animal-feed composition according to the invention is advantageously gluten-free. Gluten forms the generic tem′ for cereal proteins. They consist of two fractions, wherein one of the two is alcohol soluble. Gluten is contained in cereal-based animal feed products and represents a trigger for allergies through the feed in the case of pets. By substituting cereals with potato flour, a large number of feed allergies can be prevented. As a result of the specific composition and the freedom from gluten, the animal-feed composition according to the invention is also readily digested by sensitive pets.

The cereal protein of some species, such as wheat, spelt, rye, barley or triticale is designated as gluten. Other cereal species such as maize, rice or millet are gluten-free.

Pseudo-cereals are gluten-free.

According to one preferred embodiment of the present invention, the animal-feed composition is manufactured through co-extrusion of the inner component within the outer component.

Advantageously, an improved sensation in the mouth and accordingly enhanced acceptance by the consuming animal results from the co-extrusion of the inner component within the outer component.

The use of potato flour in the inner component, which contains potato starch, improves the sensation in the mouth of the multi-component animal-feed composition according to the invention through the uniform shape of the starch grains.

Through the improved hydrolysis of the potato starch by comparison with cereal-based products, a more uniform and denser pore density and a reduced transfer of fat from the inner into the outer component occurs. Advantageously, both the organoleptic properties of the product and the acceptance by the consumer are improved as a result.

Potato starch gelatinises even at lower temperatures of 56-66° C. and is accordingly broken down, for example, better than maize starch. Maize starch gelatinises at temperatures of 75-80° C. Potato starch also gelatinises at lower temperatures than wheat starch. Wheat starch gelatinises at temperatures of 80-85° C.

For example, tapioca starch also gelatinises at 60-65° C. and therefore at lower temperatures than, for example, maize starch and wheat starch.

In its property as a gelatinising agent, potato starch contains less alpha-amylase and is accordingly also broken down enzymatically only slightly. This can be determined indirectly via the simulation in the amylograph.

The texture, the appearance and the taste are counted among the organoleptic properties of the animal-feed composition according to the invention.

Through co-extrusion of the inner component within the outer component, the product can be fed better by hand. In one preferred embodiment, the inner component is characterised by a high fat content. Through co-extrusion of the inner within the outer component, the inner component is completely enclosed by the outer component. As a result, an escape of fat and a resulting greasy surface of the product is prevented.

Through co-extrusion of the inner component within the outer component, the inner component is completely enclosed by the outer component. An air seal is achieved by the outer component and consequently an increased storage stability of the product.

According to one advantageous embodiment of the invention, the use of simple packaging techniques is made possible, because the softer, inner component is completely enclosed by the outer, harder component and consequently, an escape of the softer, inner component is prevented.

The animal-feed composition according to the present invention can comprise a maximum dimension from 6 to 35 mm and a second maximum dimension from 5 to 25 mm.

Advantageously, the animal-feed composition according to the present invention can comprise a weight from 0.2 to 8 g per piece, preferably a weight from 0.35 to 5 g per piece.

By preference, the outer component of the animal-feed composition comprises a potato flour content of at least 10% by weight, preferably a potato flour content of at least 30% by weight, by further preference a potato flour content of at least 50% by weight, and the inner component comprises a potato flour content of at least 40% by weight, preferably a potato flour content of at least 45% by weight, by further preference a potato flour content of at least 50% by weight.

Potato flour induces a high satisfaction index. Advantageously, the present invention can provide feed compositions for overweight pets. The feeling of satisfaction occurs more rapidly in consuming animals, so that the quantity consumed can be reduced.

By further preference, the content by weight of the outer component is at least 40% by weight, preferably at least 60% by weight, by further preference at least 80% by weight, and the content of the inner component is at least 10% by weight, preferably at least 20% by weight, by further preference at least 25% by weight.

In a further embodiment, the outer component of the animal-feed composition comprises a pseudo-cereal content of at least 10% by weight, preferably of at least 30% by weight, by further preference at least 50% by weight, and the inner component comprises a pseudo-cereal content of at least 40% by weight, preferably of at least 45% by weight, by further preference of at least 50% by weight.

In one preferred embodiment, the outer component of the animal-feed composition comprises a tapioca content of at least 10% by weight, preferably of at least 30% by weight, by further preference of at least 50% by weight, and the inner component comprises a tapioca content of at least 40% by weight, preferably of at least 45% by weight, by further preference at least 50% by weight.

In one preferred embodiment of the present invention, the total moisture content of the outer component of the animal-feed composition is less than 18% by weight, preferably less than 15% by weight, by further preference less than 12% by weight, by further preference less than 8% by weight.

By preference, the outer component of the present invention further contains at least one ingredient selected from a fat, a protein or a combination of the same. On the basis of the specific water-binding properties of the potato flour contained in the outer component and its excellent swelling and gelatinising properties, the outer component is characterised by a fine, smooth structure, wherein the outer component is crunchier and the inner component is creamier.

Advantageously, the inner component of the animal-feed composition of the present invention contains a mixture of lipids and solid ingredients. With the solid ingredients, the lipids form a matrix, which is softer than the outer component. The softer inner component is formed without the addition of water and therefore has a minimal water content and extremely low water activities. Accordingly, the inner component does not necessitate strict sterilisation measures or antimicrobial and/or antimycotic treatments for stabilisation.

The softer inner component of the animal-feed composition according to the present invention advantageously comprises a water activity, a_{w}, of less than 0.7, preferably a water activity, a_{w}, of less than 0.6, by further preference a water activity, a_{w}, of less than 0.5.

By preference, the softer inner component comprises a water activity, a_{w}, of less than 0.4, preferably a water activity, a_{w}, of less than 0.3, by further preference a water activity, a_{w}, of less than 0.2.

The mixture of lipids and solids of the softer, inner component of the animal-feed composition of the present invention also advantageously contains a lipid, which comprises a saturated or unsaturated, long-chained or medium-chained mono-, di- or triacylglycerol.

Advantageously, the lipid content of the inner, softer component of the animal-feed composition according to the invention is greater than 35% by weight, further advantageously greater than 40% by weight, by particular preference greater than 50% by weight.

The inner component accordingly forms a creamy texture without the addition of water.

In one preferred embodiment, the inner component of the animal-feed composition of the present invention further contains an ingredient selected from fats, proteins and combinations of the same.

In a further aspect of the present invention, the softer, inner component of the animal-feed composition further includes at least one additional ingredient selected from nutritional or non-nutritional compounds, functional compounds, pharmaceutical compounds and mixtures of the same. The present invention can accordingly serve as a supply system for different nutrients, non-nutrient substances, functional and/or pharmaceutical compounds. Such additives can be ingredients which improve the skin or fur properties of the consuming animal, can act in an anti-inflammatory manner, improve the smell of the breath, reinforce the immune response, or combat parasites and/or microorganisms. Such functional ingredients are represented, for example, by curcumin, rosemary oil, parsley-seed oil, evening primrose oil.

In particular, through the present invention, such ingredients which are sensitive to heat, light and oxygen can be added to the inner component, because the inner component is completely enclosed by the outer component, and functional ingredients can be substantially protected from heat, light and oxygen.

Advantageously, the nutritional compounds within the inner component of the animal-feed composition can be selected from minerals, vitamins and mixtures of the same. The body can therefore be supplied with important nutrients, so that, for example, the metabolism is supported and the well-being of the consumer can be enhanced.

By preference, the non-nutritional compounds contained in the inner component of the animal-feed composition are selected from plant compounds, plant-based extracts and mixtures of the same. The non-nutritional compounds can preferably comprise cellulose-fibre. Such compounds and extracts can act, for example, in an anti-inflammatory manner.

In one preferred embodiment of the present invention, the softer, inner component according to the invention further contains at least one additional ingredient selected from antioxidant ingredients, anti-inflammatory ingredients, pre-biotics and/or pro-biotics. Antioxidant ingredients reduce the oxidative stress in the respective consumer, for example, in cats. Pre-biotics and pro-biotics, for example, inulin or fructo-oligosaccharides support the function of the intestinal flora and therefore increase the digestibility of the feed composition according to the invention, the well-being and the health of the consumer.

In one preferred embodiment, the animal-feed composition according to the invention is manufactured through co-extrusion of the inner component within the outer component.

### DRAWINGS

In the following, the invention is described in greater detail with reference to the accompanying drawings, which show a preferred embodiment of the invention.

FIG. 1 shows a schematic cross-sectional view of an animal-feed composition according to the present invention.

FIG. 2 shows a schematic cross-sectional view of an animal-feed composition according to the present invention. 1 describes the harder, outer component of the animal-feed composition, which encloses the softer, inner component 2 of the animal-feed composition.

### EXAMPLES

The examples should not be seen as restrictive for the invention.

### Example 1

An animal-feed composition according to the invention comprises the following components:

| | | Outer | Inner |
|---|---|---|---|
| | Total [%] | component [%] | component [%] |
| Potato protein | 14 | 17.5 | |
| Potato flour | 23 | 28.75 | 48 |
| Cereal-free filling | 20 | | |
| Poultry-meat powder | 26 | 32.5 | |
| Poultry-meat hydrolysate | 5 | 6.25 | |
| Poultry fat | 5 | 6.25 | 50 |
| Lignocellulose | 4 | 5 | |
| Milk powder | 2.5 | 3.125 | 2 |
| Vitamins | 0.3 | 0.375 | |
| Minerals | 0.2 | 0.25 | |
| Total | 100 | 100 | 100 |

### Example 2

The following example visualises the increased acceptance and palatability of an animal-feed composition according to the present invention.

The feed performance and feed preference of an animal-feed composition according to the present invention based on potato flour was investigated by comparison with a comparable, cereal-based product in cats (n=20) of different age groups (age: 1 to 9 years). Test methods for determining feed performance and feed preference are well-known to the person skilled in the art in the field of animal nutrition.

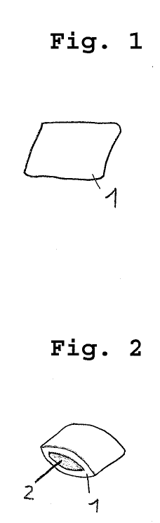

The feed preference test showed that 85% of the cats preferred the animal-feed composition according to the present invention, comprising two components of which both components are based on potato flour and, as shown in FIGS. 1 and 2, an outer component 1 forms a skin around an inner component 2, while 15% of the cats preferred the conventional cereal-based animal feed.

### Example 3

In the following example, it was tested whether cats prefer the animal-feed composition according to the invention without cereal ingredients by comparison with cereal-containing animal-feed composition.

The feed performance and feed preference of an animal-feed composition according to the present invention based on potato flour was investigated by comparison with a comparable, cereal-based product in cats (n=20) of different age groups (age: 1 to 9 years). Test methods for determining feed performance and feed preference are well-known to the person skilled in the art in the field of animal nutrition.

The feed preference test showed that 60% of the cats preferred the animal-feed composition according to the present invention, comprising two components of which both components are based on potato flour and, as shown in FIGS. 1 and 2, an outer component 1 forms a skin around an inner component 2, while 40% of the cats preferred the conventional cereal-based animal feed.

### LIST OF REFERENCE NUMBERS

1 Outer component of the animal-feed composition
2 Inner component of the animal-feed composition

1. An animal-feed composition comprising two components, an outer component which completely encloses an inner component, wherein the outer component contains potato flour and furthermore at least one ingredient selected from a fat, a protein or a combination of the same and is harder than the inner component.

2. The animal-feed composition according to claim 1, wherein the inner component contains potato flour.

3. The animal-feed composition according to claim 1, characterised in that the outer component is free from cereal constituents.

4. The animal-feed composition according to claim 1, characterised in that the inner component is free from cereal constituents.

5. The animal-feed composition according to claim 1, characterised in that it is manufactured by co-extrusion of the inner component within the outer component.

6. The animal-feed composition according to claim 1, characterised in that it comprises a maximum dimension of 9 to 35 mm and a second maximum dimension of 7 to 25 mm.

7. The animal-feed composition according to claim 1, characterised in that it comprises a weight from 0.2 to 8 g per piece, preferably a weight from 0.35 to 5 g per piece.

8. The animal-feed composition according to claim 1, characterised in that the outer component comprises a potato flour content of at least 10% by weight, preferably a potato flour content of at least 30% by weight, by further preference a potato flour content of at least 50% by weight, and the inner component comprises a potato flour content of at least 40% by weight, preferably a potato flour content of at least 45% by weight, by further preference a potato flour content of at least 50% by weight.

9. The animal-feed composition according to claim 1, characterised in that the content by weight of the outer component is at least 40% by weight, preferably at least 60% by weight, by further preference at least 80% by weight, and the content of the inner component is at least 10% by weight, preferably at least 20% by weight, by further preference at least 25% by weight.

10. The animal-feed composition according to claim 1, characterised in that the outer component comprises a total moisture content of less than 18% by weight, preferably a total moisture content of less than 15% by weight, by further preference a total moisture content of less than 12% by weight.

11. The animal-feed composition according to claim 1, characterised in that the inner component contains a mixture of lipids and solid ingredients.

12. The animal-feed composition according to claim 1, characterised in that the inner component comprises a water activity, a_{w}, of less than 0.4, preferably a water activity, a_{w}, of less than 0.3, by further preference of less than 0.2.

13. The animal-feed composition according to claim 1, characterised in that the mixture of lipids and solids contains a lipid, which comprises a saturated or unsaturated, long-chained or medium-chained mono-, di-, or triacyl glycerol.

14. The animal-feed composition according to claim 1, characterised in that the lipid content of the inner component is greater than 35% by weight, preferably greater than 50% by weight.

15. The animal-feed composition according to claim 1, characterised in that the inner component further contains an ingredient which is selected from fats, proteins and combinations of the same.

16. The animal-feed composition according to claim 1, characterised in that the inner component further contains an additional ingredient selected from nutritional or non-nutritional compounds, functional compounds, pharmaceutical compounds and mixtures of the same.

17. The animal-feed composition according to claim 16, characterised in that the nutritional compounds are selected from minerals, vitamins and mixtures of the same.

18. The animal-feed composition according to claim 16, characterised in that the non-nutritional compounds are selected from plant compounds, plant-based extracts and mixtures of the same.

19. The animal-feed composition according to claim 1, characterised in that the inner component further contains an additional ingredient selected from antioxidant ingredients, anti-inflammatory ingredients, pre-biotics and/or pro-biotics.

20. The animal-feed composition according to claim 1, characterised in that it can be manufactured by co-extrusion of the inner component with the outer component.
